(19) United States
(12) Patent Application Publication
(10) Pub. No.: US 2009/0121986 A1
(43) Pub. Date: May 14, 2009

(54) DISPLAY APPARATUS WITH SOLID STATE LIGHT EMITTING ELEMENTS

(75) Inventors: Jia-Jin Tu, Chu-Nan (TW); Chun-Wei Wang, Chu-Nan (TW)

Correspondence Address: PCE INDUSTRY, INC.;ATT. Steven Reiss, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/248,285

(22) Filed: Oct. 9, 2008

(30) Foreign Application Priority Data
Nov. 9, 2007 (CN) 200710202458.5

(51) Int. Cl. G09G 3/32

(52) U.S. Cl. 345/82

(57) ABSTRACT

A display apparatus includes a display system and a control system. The display system includes pixel units and a network interface based on a network protocol. The pixel units are arranged in a matrix and each of the pixel units includes solid state light emitting elements. The control system includes a control module, an input module, and an output module. The output module is electronically coupled to the network interface. The control system is configured to receive an input signal through the input module, generate a corresponding control signal by the control module, and output the control signal by the output module to the display system via the network interface according to the network protocol to control the display contents of the display system.

### BACKGROUND

1. Technical Field

The present invention relates to display apparatuses, and particularly, to a display apparatus with solid state light emitting elements.

2. Description of Related Art

Solid state light emitting elements, such as light emitting diodes (LEDs) have been widely used in display apparatuses.

A typical LED display apparatus is made up of a plurality of pixel units arranged in a matrix having rows and columns. Each of the pixel units is made up of several LEDs. In a full color LED display apparatus, each of the pixel units is comprised of at least one red LED, one green LED, and one blue LED. Each of the pixel units can produce a specific perceived light intensity depending on the amount of current supplied to the LEDs.

In the typical LED display apparatus, several LEDs are connected to a data bus, i.e., in a serial form. However, if the data bus malfunctions, all of the LEDs connected to the data bus will not work. As a result, data transmission is no longer reliable.

What is needed, therefore, is a display apparatus to overcome the above described shortcoming.

### SUMMARY

A display apparatus includes a display system and a control system. The display system includes a plurality of pixel units arranged in a matrix and a network interface based on a network protocol. Each of the pixel units includes a plurality of solid state light emitting elements. The control system includes a control module, an input module and an output module. The output module is electronically coupled to the network interface. The control system is configured to receive an input signal through the input module, generate a corresponding control signal by the control module, and output the control signal by the output module to the display system via the network interface according to the network protocol to control the display contents of the display system.

Other advantages and novel features of the present display apparatus will become more apparent from the following detailed description of embodiment when taken in conjunction with the accompanying drawings.

### BRIEF DESCRIPTION OF THE DRAWINGS

Many aspects of the display apparatus can be better understood with reference to the following drawings. The components in the drawings are not necessarily drawn to scale, the emphasis instead being placed upon clearly illustrating the principles of the present display apparatus. Moreover, in the drawings, like reference numerals designate corresponding parts throughout the several views.

FIG. 1 shows a structure of one embodiment of a display apparatus, the display apparatus including a display system including a plurality of pixel units.

FIG. 2 shows a structure of a first embodiment of a pixel unit of the display apparatus of FIG. 1.

FIG. 3 shows a structure of a second embodiment of a pixel unit of the display apparatus of FIG. 1.

### DETAILED DESCRIPTION OF THE EMBODIMENTS

Embodiment of the present display apparatus will now be described in detail below and with reference to the drawings.

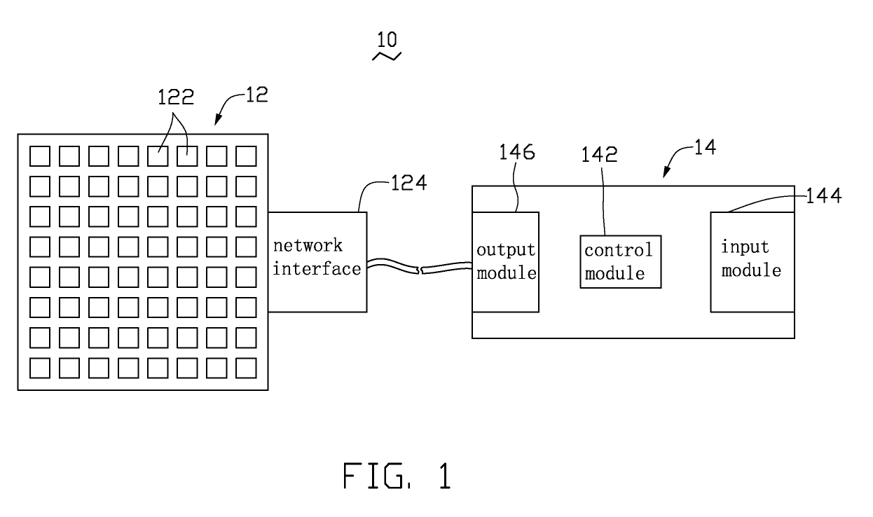

Referring to FIG. 1, a display apparatus 10 includes a display system 12, and a control system 14.

The display system 12 includes a plurality of pixel units 122 and a network interface 124 based on a network protocol. The pixel units 122 are arranged in a matrix having rows and columns. In one embodiment, the network protocol may be a transfer control protocol (TCP) and an internet protocol (IP). In other embodiments, the network protocol may be varied according to need.

The control system 14 includes a control module 142, an input module 144 and an output module 146. The output module 146 is electronically coupled to the network interface 124. The control system 14 is configured to receive an input signal through the input module 144, generate a corresponding control signal by the control module 142, and output the control signal by the output module 146 to the display system 12 via the network interface 124 according to the network protocol.

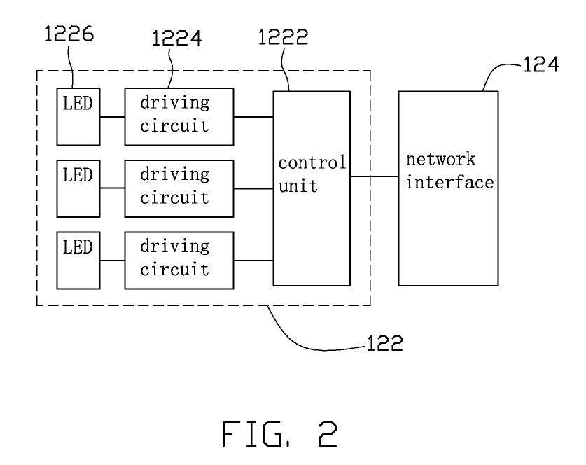

Also referring to FIG. 2, a structure of a first embodiment of the plurality of pixel units 122 is shown. Each pixel unit 122 includes a control unit 1222, a plurality of driving circuits 1224, and a plurality of light emitting diodes (LEDs) 1226. The plurality of LEDs 1226 includes a red LED, a green LED, and a blue LED. The control unit 1222 is configured to receive and convert the control signal transferred via the network interface 124 into a driving signal. The control unit 1222 may be a pulse width modulator. Each of the driving circuits 1224 is connected to the each corresponding LED 1226, and configured to provide a driving current to each corresponding LED 1226 based on the driving signal.

The control module 142 may be installed in a Windows or Linux operating system.

The input module 144 may have a memory card reading unit to receive data from a memory card, a data inputting interface to receive inputted data, and a wireless data receiving unit, such as a bluetooth receiving unit to wirelessly receive inputted data.

The output module 146 is configured to output the control signal from the control module 142 to the plurality of pixel units 122 via the network interface 124 according to the network protocol.

In the display apparatus 10, the network interface 124 is applied to the display system 12, each of the pixel units 122 is connected to the network interface 124. As a result, a more reliable data transmission and a long-distance control can be achieved.

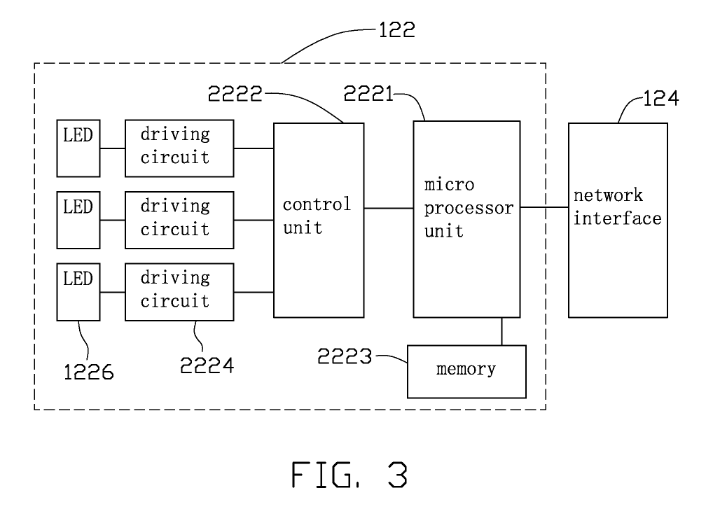

Referring to FIG. 3, a second embodiment of the plurality of the pixel units 122 is shown. Each of the pixel units 122 includes a control unit 2222, a plurality of driving circuits 2224, and a plurality of LEDs 1226, a memory 2223, and a micro processor unit 2221.

The memory 2223 is configured to memorize a color/brightness value of each of the pixel units 122. The memory 2223 may be an electrically erasable programmable read only memory or a flash memory. The micro processor unit 2221 is configured to receive the control signal from the control system 14 and a currently detected color/brightness value of each of the pixel units 122, and adjust the control signal based on residual values between the initial color/brightness value and the currently detected color/brightness value. The control unit 2222 is configured to receive and convert the adjusted control signal into a driving signal. Each of the driving circuits 2224 is connected to each corresponding LED 1226 and configured to provide a driving current for each corresponding LED 1226 based on the driving signal.

The light intensity value of each of the pixel units 122 may be externally detected by a charge coupled device arranged adjacent to each of the pixel units 12. Due to the configuration of the micro processor unit 2221 and the memory 2223, light output decay of the LEDs 1226 can be compensated.

It may be appreciated that the LEDs 1226 can also be replaced by other solid state light emitting elements.

It is understood that the above-described embodiments are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. A display apparatus, comprising:
a display system comprising a plurality of pixel units arranged in a matrix and a network interface based on a network protocol, each of the pixel units comprising a plurality of solid state light emitting elements; and
a control system comprising a control module, an input module, and an output module electronically coupled to the network interface, wherein the control system is configured to receive an input signal through the input module, generate a corresponding control signal by the control module, and output the control signal by the output module to the display system via the network interface according to the network protocol to control the display contents of the display system.

2. The display apparatus as described in claim 1, wherein the network protocol includes a transfer control protocol and an internet protocol.

3. The display apparatus as described in claim 1, wherein the plurality of solid state light emitting elements of each of the pixel units comprises at least one red light emitting element, at least one green light emitting elements, and at least one blue light emitting elements.

4. The display apparatus as described in claim 3, wherein each of the solid state light emitting elements is a light emitting diode.

5. The display apparatus as described in claim 1, wherein each of the pixel units further comprises a control unit and a plurality of driving circuits; the control unit is configured to receive and convert the control signal transferred via the network interface into a driving signal; each of the multiple driving circuits is connected to each corresponding multiple solid state light emitting element and configured to provide a driving current for each solid state light emitting element based on the driving signal.

6. The display apparatus as described in claim 1, wherein each of the pixel units further comprises a control unit, a plurality of driving circuits, a memory, and a micro processor unit; the memory is configured to memorize an initial color/brightness value of each of the pixel units; the micro processor unit is configured to receive the control signal and a currently detected color/brightness value of each of the pixel units, and adjust the control signal based on residual values between the initial color/brightness value and the currently detected color/brightness value; the control unit is configured to receive and convert the adjusted control signal into a driving signal; each of the driving circuits is connected to each corresponding solid state light emitting element and configured to provide a driving current for each corresponding solid state light emitting element based on the driving signal.

7. The display apparatus as described in claim 6, wherein the light intensity value of each of the pixel units is detected by a charge coupled device.

8. The display apparatus as described in claim 6, wherein the memory is selected from the group consisting of an electrically erasable programmable read only memory and a flash memory.

9. The display apparatus as described in claim 1, wherein the input module has a memory card reading unit.

10. The display apparatus as described in claim 1, wherein the input module has a data inputting interface.

11. The display apparatus as described in claim 1, wherein the input module has a wireless data receiving unit.
